(19) United States
(12) Patent Application Publication
(10) Pub. No.: US 2024/0367394 A1
(43) Pub. Date: Nov. 7, 2024

(54) NON-CRIMP FIBRE FORMING

(71) Applicant: GKN Aerospace Services Limited, Shirley, Solihull (GB)

(72) Inventors: Stephen Williams, Shirley, Solihull (GB); Clement Ooi, Shirley, Solihull (GB)

(21) Appl. No.: 18/562,964

(22) PCT Filed: May 25, 2022
(86) PCT No.: PCT/GB2022/051311

§ 371 Date: Nov. 21, 2023

(30) Foreign Application Priority Data
May 27, 2021 (GB) 2107573.4

(51) Int. Cl. B29C 70/56; B29C 70/44; B29C 70/48; B29C 70/54; B29K 105/08; B29K 307/04; B29L 31/30

(52) U.S. Cl. CPC B29C 70/56; B29C 70/446; B29C 70/541; B29C 70/543; B29C 70/48; B29K 2105/0854; B29K 2307/04; B29L 2031/3085

(57) ABSTRACT

A component can be formed from a non-crimp fibre material, by using a forming tool over which a layer of non-crimp fibre is to be drawn, wherein the layer of non-crimp material is drawn over the tool by forming boards extending around all or part of the periphery of the tool using an elastic material.

### CROSS-REFERENCE TO RELATED APPLICATIONS

This application is a national stage of, and claims priority to, Patent Cooperation Treaty Application No. PCT/GB2022/051311, filed on May 25, 2022, which application claims priority to United Kingdom Application No. GB 2107573.4, filed on May 27, 2021, which applications are hereby incorporated herein by reference in their entireties.

### BACKGROUND

In aerospace applications, spars can be used in wings, horizontal or vertical tail-planes (empennage), in tail-booms of helicopters, and smaller structures in components such as winglets and flaps where rigidity is required.

An aircraft wing comprises an outer aerodynamic surface over which air is caused to flow by forward motion of the aircraft. Wings generally comprise one or more spars extending within the wing from the root, where the spar connects to the fuselage, to the wing tip.

The shape and contour of the spar and associated ribs (which run in a fore-aft direction of flight of the aircraft) corresponds to the desired shape of the aerofoil. The outer aerodynamic surface can then be connected to the ribs and spar (by various means) to form the wing.

One conventional way of manufacturing spars is to machine the spar from a billet of aluminium or other lightweight material using CNC tools so that the precise geometry of the spars can be obtained. Conventional wings made using these techniques allow a lightweight wing to be manufactured accurately for each aircraft design providing the desired strength and stiffness.

### SUMMARY

The present disclosure is concerned with the manufacture of the structural component in aircraft wings known in the art as spars. The present process for optimising wing design and in particular wing spar manufacture allows non-crimp forming techniques to be successfully and economically deployed. Although the manufacturing method is particularly suited to aircraft spar manufacture, it may be employed in other related applications or components with a similar shape.

For example, the technology may be used in a variety of applications using non-crimp fabrics (NCF) to form complex 3 dimensional shapes. A technique may also be used with other material formats such as plain or harness weave fabrics. It is particularly relevant to dry fabric which will slip and shear more easily than traditional pre-impregnated materials which would require heat to lower the resin viscosity. Aspects are set out in the accompanying claims.

Viewed from a first aspect there is provided a Non-Crimp Fabric (NCF) forming apparatus comprising at least one pair of opposing moveable former boards, the formed boards being arranged for positioning on opposing sides of a forming tool and movable between a first position above an upper surface of the forming tool to a second position lower than the first, wherein each former board has a former edge which is moveable relative to the side surfaces of the forming tool, the former boards further comprising one or more couplings arranged in use to receive an elastic connector for coupling, in use, to a length of Non-Crimp Fabric.

A manufacturing apparatus described herein allows a non-crimp fabric material to be precisely positioned on a forming tool in a way that allows high accuracy multi-layer components such as aircraft spars to be formed. Furthermore, more complex geometries can be realised in the final component providing the designer with greater flexibility to optimise strength to weight ratios.

The formed borders may be in the form a series of movable surfaces ending along either side of the tooling. They may be collectively or independently moved with respect to the tool.

The terms ‘elastic connector’ herein means an intermediate connection between a sheet of non-crimp fabric (which is to be draped over the tool) and the former boards which can stretch elastically between the tool and the movable former boards. This may be a single continuous strip or a plurality of strips, where each strip able to stretch as the separation between former board and tool is increased or decreased.

Advantageously the moveable former boards may be further arranged to optionally move laterally away from or towards each other before and during movement from the first to the second position. This allows for dexterity in how the fabric material is laid over the tooling and allows a precise pre-tension to be applied to the fabric, as described below.

As the moveable former boards move from the first to the second positions they may be configured to move vertically and laterally towards a respective side of a forming tool. This allows for the fabric to be carefully brought into contact with corners and geometries of the tool upper and side surfaces.

Similarly, the moveable former boards may be configured so as to first move in a vertical direction by a predetermined distance and then simultaneously both vertically and laterally towards a respective side of a forming tool. Precise alignment of the fabric with respect to the tool can then be achieved. Additionally, all or parts of the movement may be computer controlled.

The one or more couplings may be arranged on a distal portion of the former edge with respect to the tool. Thus, the coupling that connects the elastic connector to the former boards may be coupled thereto at a part of the board most distant from the tool. This allows for convenient loading of the materials onto the former boards and furthermore allows the coupling to be made on an opposing side surface of the former board to the tool. Thus, the elastic connector must pass around part of the outer surface of the former board which improves coupling strength.

The elastic connector and couplings may be in the form of an elastomeric film (such as a thin film manufactured by Tygavac) and two adhesive strips respectively. The adhesive strips may conveniently be double-sided adhesive tapes (of the type manufactured by 3M) which allows the elastic connector to be easily connected along one end or edge to the NCF and on the other edge or end to the former board.

Examples of materials that may conveniently be used include, but are not limited to:
2 ply NCF non-woven fabrics;
double sided tape comprising polyester film, being 150 μm-250 μm in thickness, having an acrylic adhesive and an adhesive strength of 15N/cm-25N/cm;
25 micron high elongation fluoropolymer film; and
polyester tape with silicone adhesive applied to both sides.

The apparatus may further comprise a pressure box configured to be lowered over the forming tool and comprising an inflatable bladder configured upon expansion to apply a force to the outer surface of the forming tool. Thus, once the forming boards have completed their movement path to place the NCF in position the pressure box can be lowered over the tool and located against the NCF material. The forming boards may advantageously remain in their final position as this happens.

The forming tool itself may be any suitable shape as required by the desired part being manufactured. For example, the forming tool may be in the form of an elongate mandrel having upper and side surfaces against which a length of non-crimp fabric may be drawn.

Viewed from another aspect there is provided a method of forming a component from a non-crimp fibre (NCF) material, the method comprising the steps of
(A) coupling portions of the periphery of a layer of NCF material to one or more moveable former boards of a laying up apparatus, wherein the coupling is by means of an intermediate elastic material;
(B) causing the moveable former boards to move apart so as to place a tensile load on the intermediate elastic material; and
(C) causing the moveable former boards to move from a first position above a forming tool to a second position below the first so as to bring the layer of NCF material into contact with the forming tool.

Advantageously the intermediate elastic material may be maintained in tension as the moveable former boards are moved from the first to the second position. This in turn maintains the NCF material in a small amount of tension so that it accurately aligns with the tooling as the boards move.

It will be recognised that the features and advantages described above with reference to the apparatus statements apply equally and interchangeably to the method of manufacturing.

Viewed from a still further aspect there is provided an aircraft spar formed using the apparatus and method described herein.

### BRIEF DESCRIPTION OF THE DRAWINGS

One or more embodiments will now be described, by way of example only, and with reference to the following figures in which:

FIG. 1 illustrates the internal structure of a wing;

FIG. 2A shows an illustration of a composite spar for an aircraft wing having a generally C-shaped profile and with horizontal edges at the lower portion of the spar;

FIGS. 2B to 2G show an alternative spar (viewed from different viewing angles) illustrating the complex geometry of a component that may be conveniently manufactured by a process described herein;

FIGS. 3A to 3H show the steps of the process described herein;

FIGS. 31-1 and 31-2 show alternative forms of NCF material and component parts;

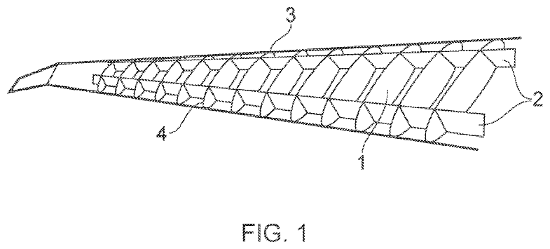

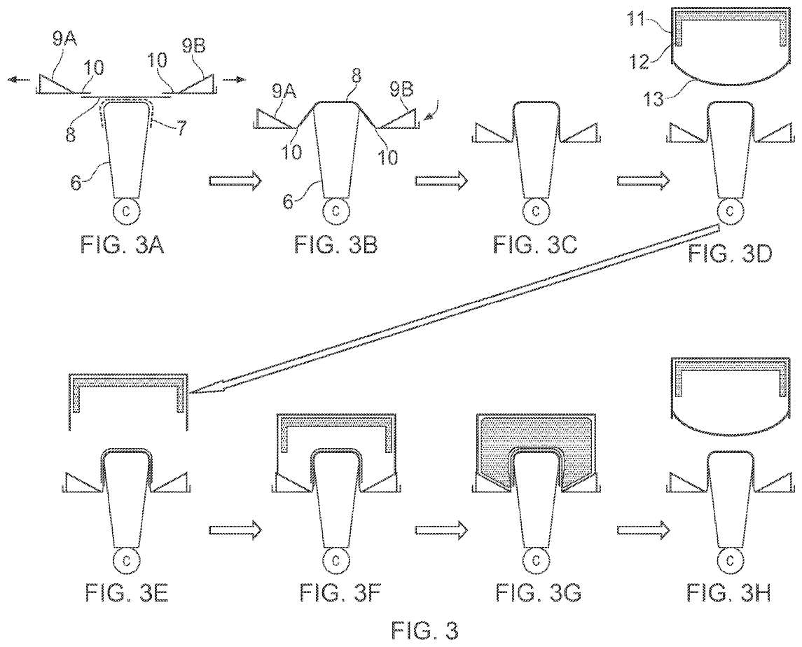

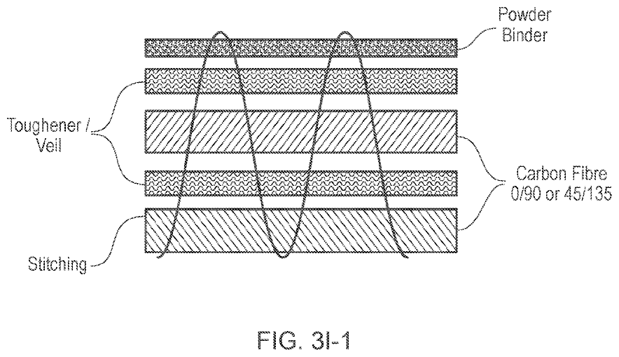

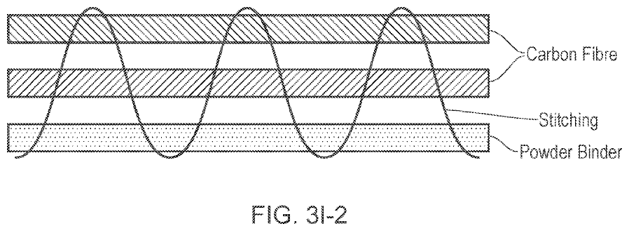

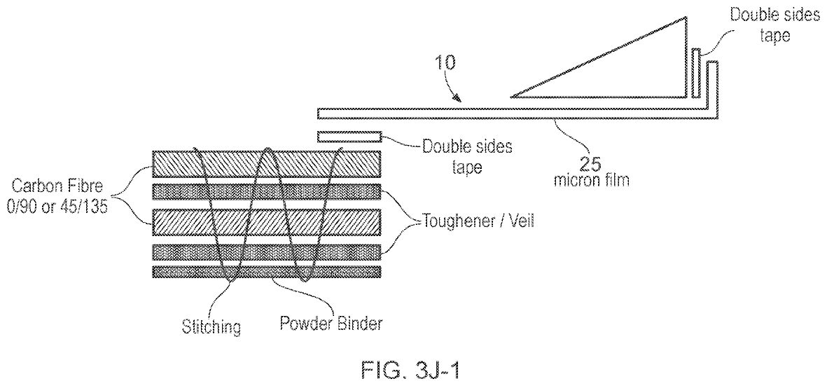

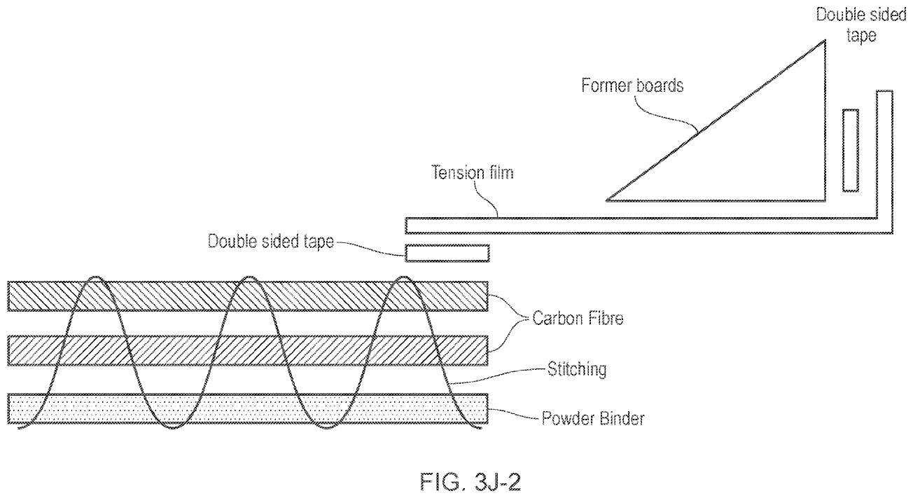

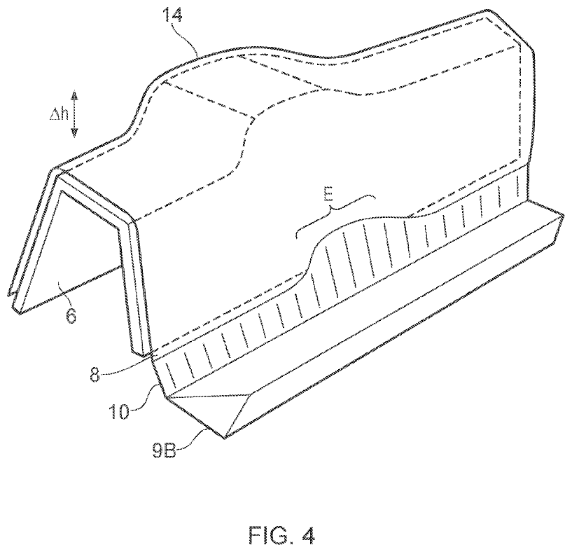

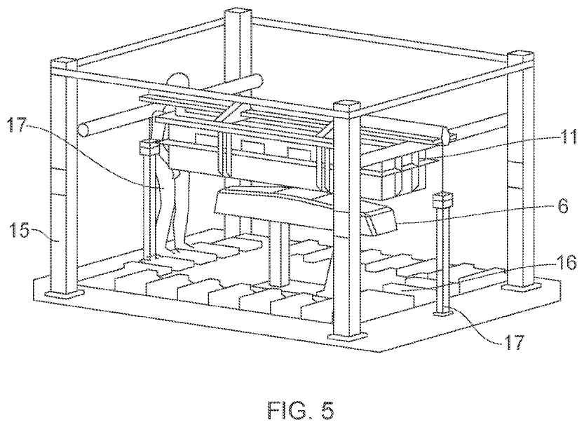

FIG. 3J-1 shows the connection of elastic intermediate layer and NCF material for arrangements 3I-1 where the tension film wraps beneath the form board and up the back where it is secured so as to minimise any peel forces on the adhesive;

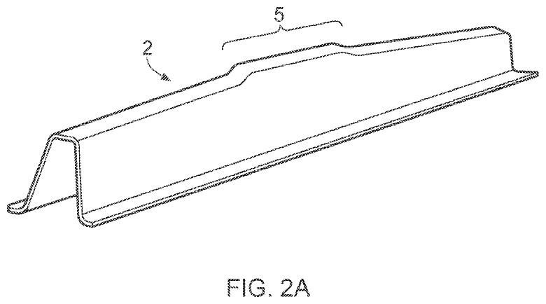

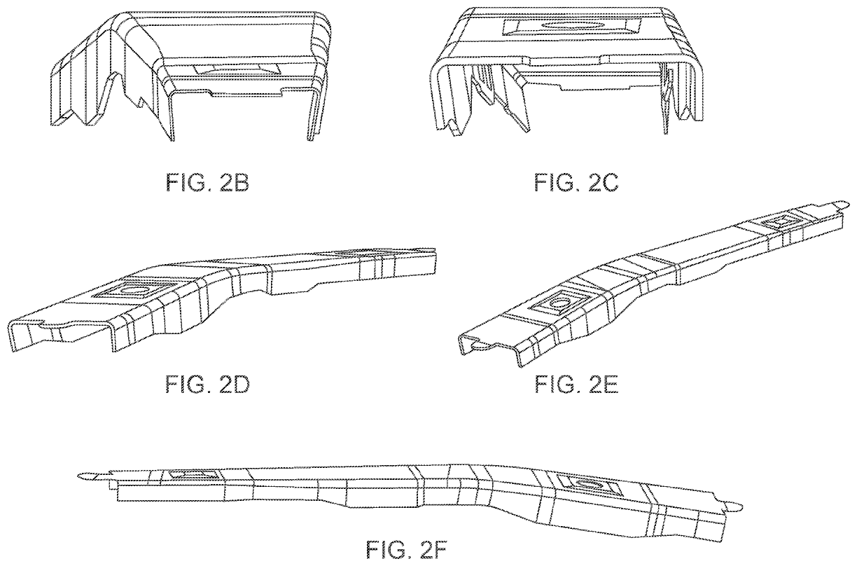

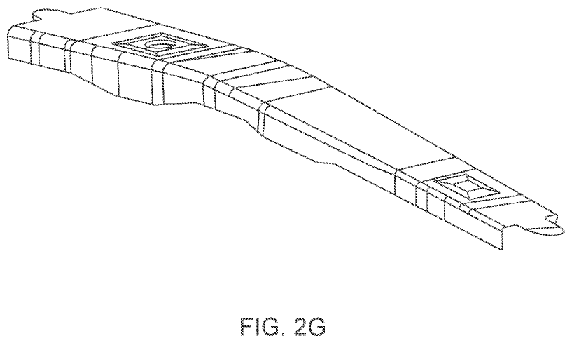

FIG. 3J-2 shows the connection of elastic intermediate layer and NCF material for arrangements 3I-2 where, again, the tension film wraps beneath the form board and up the back where it is secured so as to minimise any peel forces on the adhesive;

FIG. 4 illustrates the elongation of the elastic intermediate layer during manufacturing; and

FIGS. 5 shows an example rig assembly for the process described herein;

While the claimed invention is susceptible to various modifications and alternative forms, specific embodiments are shown by way of example in the drawings and are herein described in detail. It should be understood however that the drawings and detailed description attached hereto are not intended to limit the claimed invention to the particular form disclosed but rather the intention is to cover all modifications, equivalents and alternatives falling within the spirit and scope of the claimed invention.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

It will be recognised that the features of the aspects of the invention(s) described herein can conveniently and interchangeably be used in any suitable combination.

### DETAILED DESCRIPTION

FIG. 1 shows the internal structure of a wing. Ribs 1 and spars 2 make up the main load bearing structure of the wing. Spars run span-wise relative to the aircraft, i.e., down the length of the wing, and ribs run fore-aft between the leading edge 3 and the trailing edge 4.

FIG. 2A shows an example view of a spar of the type used in an aircraft wing. Referring back to FIG. 1, the spar is installed inside the wing structure and provides the rigidity required for the operation of the wing.

As shown in FIG. 2A the spar 2 has a generally up-turned U shape and provides high rigidity by virtue its second moment of area. The spar is formed by laying up material over a forming tool with a complementary shape to the desired spar. In the example shown in FIG. 2A the spar also comprises radially, that is horizontally, extending lower portions to the spar.

FIGS. 2B to 2BG illustrate another spar embodiment which may be particularly advantageously manufactured according to the process described herein. As illustrated in the different views of the spar, the spar comprises complex geometries and profiles along its length. The process described herein allows these complex geometries to be made for spars having extremely long lengths.

For illustrative purposes only, the spar in FIG. 2B to 2G comprises a central portion 5 which increases the complexity of the spar shape in terms of its geometry and thus the requirements for laying material over a mandrel or forming tool.

Non-crimp materials are formed of a plurality of layers, each layer having a series of strands of carbon fibres. The multiplicity of the orientation of the fibres provides the eventual cured product or component with great strength. The layers are connected together by stitching which holds the fibres in place until a resin can be applied and cured, typically in an out of autoclave environment. This is described below with reference to FIG. 3I.

The non-crimp materials described herein are inherently unsuitable for complex shapes because of the orientation of the fibres. Laying the material over complex shapes, such as in FIG. 2, is difficult. This makes their use in the current applications counterintuitive.

NCF tows are held together with stitches whereas woven materials interleave the tows, both allow the tows to slip over each other. The degree of form complexity is important as this can give rise to compression in the material during manufacture that leads to wrinkle defects in the finally formed component. Traditional techniques used are hand lamination, which are limited by scale and degree of forming force required and darting of the material to avoid wrinkles, this option has the disadvantage of making the fibres discontinuous and therefore less efficient.

The apparatus and method described herein allows and NCF material to be used to form a spar of the type illustrated in FIG. 2.

FIGS. 3A to 3H demonstrate each step of the process described herein. Each step will be described separately as follows:

### Tooling Set-Up

FIG. 3A illustrates the initial set-up of the forming apparatus before the spar is formed. First the forming tool/mandrel/drape tool 6 is placed in position. The shape of the tool corresponds to the desired final shape of the spar as will be understood by someone skilled in the art.

The outer surface against which the NCF material is to be applied. Importantly the resin is not introduced at this stage, however the form tool surface will have been treated with a chemical release agent (such as Frekote) during manufacture, this is typically wiped on and allowed to dry. This may be refreshed at a later point. A film is not applied directly to the tool surface, just instead to the edges of the NCF. Release agent is applied to the tool surface prior to use.

The next a layer or sheet 8 of the NCF material, such as TENAX-E, DRNF, manufactured by Teijin, is prepared having a length and size corresponding to the eventual shape of the spar. This is where the tension film is applied.

The process is then repeated to build the spar thickness. For example, spars for commercial airliners are approximately 20 mm at the thickest point, with an NCF of 0.5 mm thickness. Thus, the process in this example is repeated 40 times. In another arrangement multiple layers may be added to reduce manufacturing time.

The layer 8 of NCF is now connected to the pair of opposing former boards 9A, 9B. This is achieved by means of the elastic intermediate coupling film 10.

The former boards extend along each side of the forming tool and may be single elongate members or may alternatively be divided into multiple sections. The former boards act to apply the movement and force to bring the NCF material into contact with the forming tool and to hold the material in place during the process described below.

The movement of the former boards may be through any suitable actuator arrangement which may be electrically/pneumatically/hydraulically controlled. The movement may be controlled manually or using computer control, perhaps with a pre-programmed sequence.

The next step of FIG. 3A is to pre-tension the elastic intermediate coupling which is achieved by laterally moving the two opposing former boards apart as illustrated by the arrows. Just enough tension is applied to remove the slack from the layer but without applying excessive loading to the material.

Now the NCF is ready to move into contact with the forming tool 6.

### Preliminary Forming Tool Contact

Turning to FIG. 3B the next stage of forming is shown. Here the two opposing former boards are moved in a downward and inward movement towards the forming tool 6.

As shown, this causes the ply 8 to come into initial contact with the upper surface of the forming tool, which in the example shown is a spar for an aircraft. The initial downward movement bring the upper surface into contact and the inward movement causes the NCF ply 8 to fold smoothly around the upper corners of the forming tool 6. As shown the former boards 9A and 9B are connected to the NCF ply 8 by means of the elastic intermediate coupling 10 (illustrated in FIG. 3J). The preliminary contact of NCF material and forming tool is now complete.

### Final Location of NCF Ply

Turning now to FIG. 3C, the two former boards and moved further downwards from the initial position above the top of the forming tool to the second position which is below the first. As shown, the former boards stop their movement proximate to the point at which the NCF ply terminates on the forming tool.

As also illustrated in comparing FIGS. 3B and 3C the former boards are able to simultaneously move towards each other whilst moving vertically downwards. This movement ensures the smooth application of the NCF material to the outer surface of the forming tool with the uniform movement of boards primarily keeping the material in place on the tool.

Continuously during the steps shown in FIGS. 3A to 3C, the intermediate elastic coupling remains in tension to ensure the tight and smooth application of the NCF material against the outer forming tool surface. The maximum actual elongation of the elastic coupling may be between 40% and 60% or advantageously approximately 50%. In other examples the value may be as low as 10%.

### Location of Heater Mat and Bladder Box

As illustrated in FIG. 3D, the apparatus further comprises a heating mat and bladder box arrangement as shown in the upper part of FIG. 3D.

The bladder box 11 comprises an outer rigid housing which contains an inflatable bladder 12. Inflatable bladders are known in the art of resin transfer moulding. The bladder box 11 provides and inner surface against which the inflatable bladder 12 can react when it is inflated causing the lower surface of the bladder to move in a generally vertical direction.

The bladder box 11 further comprises a heater mat 13. A heater mat will be understood by those skilled in the art, but is essentially an electrically operated flexible mat that can conform to the shape of the component, i.e., the ply/NCF making the component. Importantly there is no resin at this point of the process. Resin transfer may take place in a different manufacturing cell. The heater blanket is used to activate a binder on the dry fabric to allow subsequent plies to stick to each other.

At step 3D the former boards are locked in position and will not be moved until the cure of the binder layer is complete.

### Heater Mat location

Once the ply layer(s) have all been located over the forming tool the heater mat can be lowered into position and into contact with the NCF material. This is illustrated by FIG. 3D. Heating the NCF from the outside as opposed to heating the tool makes the heat cycle quicker and lowers the time at temperature exposure of the lower layers. The new layer is tacked (cured) only to the previous layer below each time.

### Positioning Bladder Box

The bladder box 11 is then lowered into position as shown in FIG. 3F and secured relative to the forming tool to that expansion of the bladder 12 applies an external load to the outer surface of the NCF material against the forming tool. As illustrated in FIG. 3F the layers of the forming tool, NCF material, and heater mat are shown.

### Bladder Expansion and Cure

FIG. 3G illustrates the inflated bladder 12 within the bladder box. A predetermined pressure is applied within the inflatable bladder creating a predetermined load onto the NCF material. The heating mat is also activated to commence the melting of the thermoplastic outer tackifier layer which secures consecutive layers together. The thermoplastic tackifier is pre-applied to the NCF by the material supplier.

### Bladder Removal and Tack Cycle

At step 3G the heater is activated for a period of time to melt the thermoplastic binder and then deactivated to allow the binder to cool and solidify (at approximately 40 degrees C.). Next the pressure is removed. In effect at step 3G the heater is both activated and de-activated.

As shown in FIG. 3H the bladder is deflated and the bladder box removed. The elastic coupling can now be de-coupled from the NCF and the former boards returned to their start position.

FIG. 3I-1 shows the make-up of an NCF material itself that may be used in the arrangements described herein. The NCF material in FIG. 3I-1 comprises carbon fibre layers interposed between tougher or veil layers and coated within a powder binder layer as shown. The arrangement is then reinforced or held together with stitching to create the flexible fabric properties of the material.

FIG. 3I-2 shows an alternative layered structure of an NCF material having a different arrangement and composition of layers.

This is a key point and where this process may provide additional benefit, when the material is subject to a more even edge tension the fibres in the material tend to ‘flow’ around the shape better, this provides improvement in strength or efficiency compared to other methods, particularly those that rely on darting as a technique.

Referring to FIGS. 3J-1 and 3J-2, the specific connection between the NCF and each of the former boards can be described. As described herein the counterintuitive way in which the NCF material is connected to the former boards is not to use a firm and rigid connection but instead uses a flexible and elastic connection which is held in tension as the forming process is performed.

FIG. 3J-1 illustrates the connection which is in the form of an elastic layer 10 coupled on one side to the former board 9B and on the opposing side to the NCF material. In effect the connection material 10 acts as an intermediate elastic connection. The connection is shown by the example double sided tapes at either end of the elastic layer 10. As shown the layer 10 is secured to the rear surface of the former boards to ensure secure connection and allowing the necessary tension to be applied effectively.

FIG. 3J-2 illustrates the connection arrangement for the NCF structure shown in FIG. 3I-2. It will be seen that a similar forming process is applied to each NCF construct.

Suitable example materials for the layer 10 include a fluorupolymeric release film such as products manufactured by Tygavac Advanced Materials Limited.

An essential feature of the material used for the intermediate elastic connection is that it exhibits a lower tensile strength and high elasticity than the NCF material. Thus, as a tensile force is applied during the manufacturing process (described in detail below) the elastic connection or coupling stretches and thereby importantly allows the NCF material to conform more easily with the geometry of the desired component. Furthermore, although the nature of it being a film means that the load applied to the material is not necessarily directly in line with the movement of the forming equipment, it can change to act in the fibre direction of pull.

FIG. 4 illustrates step 3C as described above and illustrates how the properties of the elastic coupling allow more complex geometries such as the discontinuity 14 can be accommodated in the process.

As shown the forming tool 6 has an elongate profile but here includes a projecting portion/discontinuity which may, for example, correspond to a couple area for a spar or the like. The discontinuity 14 extends a distance Ah from the normal surface of the forming tool (illustrated by the solid and ghost line behind the NCF material 8. As shown as the former boards are moved in a vertical direction towards their second position the elastic properties of the intermediate elastic coupling 10 can stretch, i.e., elongate at region E which allow the discontinuity 14 to be formed.

Specifically, the film stretches differently at different cross sections to accommodate spar shape change and the ply is oversized compared to the finished part to allow the adhesive tapes to be cut off at the final forming step but the ply itself doesn't stretch, it shears and slips to take the form, which is directed by the tension film force.

Returning to step 3G described above, the final tensioning of the ply is achieved by the expansion of the bladder itself. The bladder inflation provides the final tension to the ply, where there is an undercut in the flanges such that the bag pushes the material against the sides. This ensures all surfaces are contacting and the heater blanket is heating the ply uniformly.

Advantageously the process described herein allows non-linear or spars with ‘kinks’ to be formed. Conventional processes require the darting process to form move complex shapes. However, the present process the tows within the fabric flow around the kink and do not buckle. This may provide additional strength to weight benefits as often these kinks are mechanically jointed with plates and bolts.

FIG. 5 illustrates a rig which can support the separate movable components of the apparatus described herein and represents one example of an implementation.

As shown an outer structure 15 supports the apparatus. A vertically moveable structure 16 is provided which can move vertically by virtue of actuators or hydraulic cylinders or the like within the corner of the structure 15. The structure 16 also carried the moveable former boards which are described above and which extend, in use, along the sides of the forming tool 6 show in the centre of the structure.

The inflatable bladder 11 is also shown in a parked position above the forming tool 6 and being movable, my means for example of a pair of hydraulic cylinders 17 independently of the vertically moveable structure 16. Thus, the moveable structure can complete the operations shown in FIG. 3A to 3C before the bladder box can be deployed and activated.

According to the present disclosure it is possible to form extremely long NCF components, including complete aircraft wing spars which can extend up to 17 metres in length. Increased lengths may be achieved with a modular manufacturing arrangement with a series of manufacturing apparatuses lined in series. This may allow for very long structural components to be formed.

1-20. (canceled)

21. A Non-Crimp Fabric (NCF) forming apparatus, comprising:
at least one pair of opposing moveable former boards, the formed boards being arranged for positioning on opposing sides of a forming tool and movable between a first position above an upper surface of the forming tool to a second position lower than the first;
wherein each former board has a former edge which is moveable relative to the side surfaces of the forming tool;
the former boards further comprising one or more couplings arranged in use to receive an elastic connector for coupling to a length of Non-Crimp Fabric.

22. The apparatus of claim 21, wherein the moveable former boards are further arranged to move laterally away from or towards each other before and during movement from the first to the second position.

23. The apparatus of claim 21, wherein as the moveable former boards are configured to move vertically and laterally towards a respective side of a forming tool as they move from the first to the second positions.

24. The apparatus of claim 23, wherein the moveable former boards are configured so as to first move in a vertical direction by a predetermined distance and then simultaneously both vertically and laterally towards a respective side of a forming tool.

25. The apparatus of claim 21, wherein the one or more couplings are arranged on a distal portion of the former edge with respect to the tool.

26. The apparatus of claim 21, where the elastic connector and couplings are in the form of an elastomeric film and two adhesive strips respectively.

27. The apparatus of claim 26, wherein an edge of the elastomeric film proximate to NCF is connected thereto by a double-sided adhesive and an edge of the elastomeric firm proximate to a former board is connected thereto by an adhesive strip.

28. The apparatus of claim 27, wherein the elastomeric film is a 25 micron film.

29. The apparatus of claim 21, further comprising a pressure box configured to be lowered over the forming tool and comprising an inflatable bladder configured upon expansion to apply a force to the outer surface of the forming tool.

30. The apparatus of claim 21, wherein the forming tool is in the form of an elongate mandrel having upper and side surfaces against which a length of non-crimp fabric may be drawn.

31. A method of forming a component from a non-crimp fibre (NCF) material, the method comprising:
(A) coupling portions of the periphery of a layer of NCF material to one or more moveable former boards of a laying up apparatus, wherein the coupling is by an intermediate elastic material;
(B) causing the moveable former boards to move apart so as to place a tensile load on the intermediate elastic material; and
(C) causing the moveable former boards to move from a first position above a forming tool to a second position below the first so as to bring the layer of NCF material into contact with the forming tool.

32. The method of claim 31, wherein the intermediate elastic material is maintained in tension as the moveable former boards are moved from the first to the second position.

33. The method of claim 31, wherein the moveable former boards are further arranged to optionally move laterally away from or towards each other before and during movement from the first to the second position.

34. The method of claim 31, wherein as the moveable former boards move from the first to the second positions they are configured to move vertically and laterally towards a respective side of a forming tool.

35. The method of claim 31, wherein the moveable former boards are configured so as to first move in a vertical direction by a predetermined distance and then simultaneously both vertically and laterally towards a respective side of a forming tool.

36. The method of claim 31, wherein the forming tool is an elongate tool and the forming boards are arranged to extend along the longest sides of the elongate tool.

37. The method of claim 31, further comprising lowering a pressure box over the forming tool, the pressure box comprising an inflatable bladder, and causing the bladder to inflate to apply a force to the outer surface of the forming tool.

38. The method of claim 31, wherein the elastic connector is in the form of a strip or length of fluoropolymer release film.

39. The method of claim 31, wherein the laying up apparatus is the apparatus of claim 21.

40. The method of claim 31, wherein the component is a spar for an aircraft wing.
